(19) United States
(12) Patent Application Publication
(10) Pub. No.: US 2020/0068106 A1
(43) Pub. Date: Feb. 27, 2020

(54) MEMBER AND METHOD OF MANUFACTURING MEMBER

(71) Applicant: CANON KABUSHIKI KAISHA, Tokyo (JP)

(72) Inventors: Toshinao Tatsuno, Utsunomiya-shi (JP); Kenji Makino, Kawasaki-shi (JP); Tomonari Nakayama, Tokyo (JP)

(21) Appl. No.: 16/539,117

(22) Filed: Aug. 13, 2019

(30) Foreign Application Priority Data
Aug. 22, 2018 (JP) 2018-155676
Aug. 5, 2019 (JP) 2019-143857

(51) Int. Cl. H04N 5/225; B05D 3/04; C03C 8/16

(52) U.S. Cl. CPC H04N 5/22521; B05D 3/0413; C03C 2205/00; H04N 5/2253; C03C 8/16; H04N 5/2252

(57) ABSTRACT

Provided are a member that reduces a change in refractive index at high humidity (60% RH or more and less than 90% RH) and a method of manufacturing the member. The member comprises a base material and a porous layer formed on at least any one of surfaces of the base material, wherein the porous layer has dN₂ of 5 nm or more and 20 nm or less and dH₂O of 25 nm or more and 75 nm or less, and has a contact angle with respect to water of less than 60°, in which dN₂ is defined as a diameter of a pore at a time when a differential pore volume becomes maximum in the differential pore distribution in nitrogen adsorption and dH₂O is defined as a diameter of a pore at a time when a differential pore volume becomes maximum in the differential pore distribution in water vapor adsorption.

### BACKGROUND OF THE INVENTION

### Field of the Invention

The present invention relates to a member excellent in hygroscopicity, especially excellent in antifogging performance and optical performance, and a method of manufacturing a member.

### Description of the Related Art

In a transparent substrate, such as glass or plastic, when the surface of the substrate reaches a temperature equal to or less than a dew-point temperature, minute water droplets adhere to the surface of the substrate, with the result that transmitted light is scattered to cause a so-called “fogging” in which transparency is impaired.

As a method of preventing fogging, there has been proposed a method involving forming a layer having hygroscopicity on the surface of the substrate and causing the layer to absorb moisture, to thereby prevent generation of water droplets. In Japanese Patent Application Laid-Open No. H11-281802, there is disclosed a method involving covering the surface of the substrate with a layer having hygroscopicity made of inorganic fine particles and a water-soluble resin.

A method involving enabling the surface of the substrate to be wet easily, to thereby suppress generation of water droplets is also conceivable. In Japanese Patent Application Laid-Open No. H11-100234, there is disclosed a method involving covering the surface of the substrate with an uneven film containing inorganic particles to enhance water wettability of the surface of the substrate, to thereby prevent fogging.

### SUMMARY OF THE INVENTION

However, the method involving preventing generation of water droplets by enhancing hygroscopicity or wettability has a problem in that a refractive index is changed due to moisture absorption or wetting at high humidity (60% RH or more and less than 90% RH).

The present invention has been made in view of the above-mentioned related art, and provides a porous layer that reduces a change in refractive index at high humidity (60% RH or more and less than 90% RH) and a method of manufacturing the porous layer.

The present invention relates to a member comprising a base material and a porous layer formed on at least one of surfaces of the base material, wherein the porous layer has dN₂ of 5 nm or more and 20 nm or less and dH₂O of 25 nm or more and 75 nm or less, and has a contact angle with respect to water of less than 60°, in which dN₂ is defined as a diameter of a pore at a time when a differential pore volume becomes maximum in the differential pore distribution in nitrogen adsorption and dH₂O is defined as a diameter of a pore at a time when a differential pore volume becomes maximum in the differential pore distribution in water vapor adsorption.

The present invention also relates to an image pickup apparatus comprising a housing, a protection cover, and an image pickup sensor arranged in an inner space surrounded by the housing and the protection cover, wherein the protection cover includes a base material and a porous layer formed on a surface of the base material on a side of the inner space, and wherein the porous layer has dN₂ of 5 nm or more and 20 nm or less and dH₂O of 25 nm or more and 75 nm or less, and has a contact angle with respect to water of less than 60°, in which dN₂ is defined as a diameter of a pore at a time when a differential pore volume becomes maximum in the differential pore distribution in nitrogen adsorption and dH₂O is defined as a diameter of a pore at a time when a differential pore volume becomes maximum in the differential pore distribution in water vapor adsorption.

The present invention also relates to a method of manufacturing the member including: preparing a silica particle dispersion liquid containing an organic silane compound having a hydrophobic functional group and silica particles in a solvent; applying the silica particle dispersion liquid onto one of a base material and another layer formed on the base material, to thereby form a coating film of the silica particle dispersion liquid; and drying the coating film, the silica particles having an average particle diameter of 8 nm or more and 25 nm or less, and the silica particle dispersion liquid containing the organic silane compound having a hydrophobic functional group in an amount of 1 wt % or more and 30 wt % or less in terms of SiO2 with respect to the silica particles.

According to at least one embodiment of the present invention, a member comprising a porous layer on a base material, and the porous layer is excellent in reduction of change in refractive index and antifogging property at high humidity (60% RH or more and less than 90% RH) can be provided.

Further features of the present invention will become apparent from the following description of exemplary embodiments with reference to the attached drawings.

### BRIEF DESCRIPTION OF THE DRAWINGS

FIG. 1 is a schematic view for illustrating a member according to at least one embodiment of the present invention.

FIG. 2 is a graph for showing dN₂.

FIG. 3 is a graph for showing dH₂O.

FIG. 4 is a schematic view for illustrating the member according to at least one embodiment of the present invention.

FIG. 5 is a schematic view of a configuration example of an image pickup apparatus using the member according to at least one embodiment of the present invention.

### DESCRIPTION OF THE EMBODIMENTS

The present invention is described in detail below.

[Member]

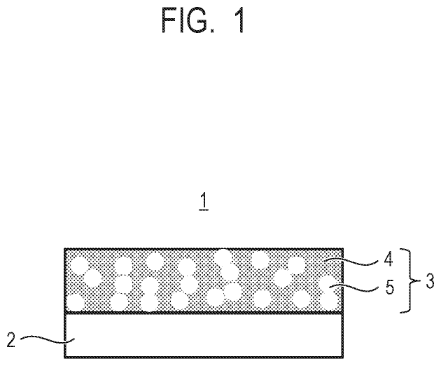

FIG. 1 is a schematic view for illustrating a member according to at least one embodiment of the present invention.

A member 1 according to at least one embodiment of the present invention includes a base material 2 and a porous layer 3.

As illustrated in FIG. 1, the porous layer 3 is porous and contains an inorganic substance 4 and pores 5. It is preferred that the pores 5 be connected to each other. In addition, the pores 5 communicate to a surface of the porous layer 3.

The porous layer 3 has a small moisture absorption amount at a humidity of less than 90% RH, and hence a change in refractive index at high humidity (60% RH or more and less than 90% RH) can be reduced, and the moisture absorption amount at ultra-high humidity, i.e., a humidity of 90% RH or more is increased. As a result, fogging does not occur even when the member 1 is exposed to such an environment that dew condensation occurs. Therefore, the member 1 according to at least one embodiment of the present invention can be used in wide applications such as a windowpane, a mirror, a lens, and a transparent film which use a transparent base material. In addition, distortion does not occur in an image passing through the member 1, and hence the member 1 is suitable particularly for optical applications, such as an optical lens, an optical mirror, an optical filter, and an eyepiece of an image pickup system and a projection system, and a planar cover and a dome cover for an outdoor camera and a monitoring camera.

(Porous Layer)

The contact angle with respect to water of the porous layer 3 is less than 60°. In this case, the contact angle refers to a contact angle obtained when pure water is dropped onto the porous layer 3 formed on the base material 2. When the contact angle is less than 60°, water molecules can sufficiently enter an inside of the porous layer 3. Therefore, the moisture absorption amount of the porous layer 3 can be ensured.

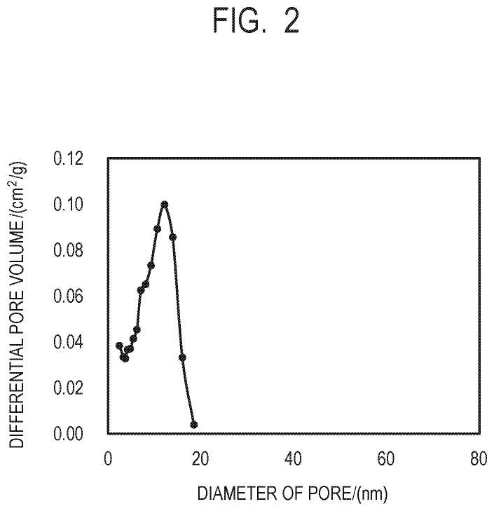

FIG. 2 is a graph for showing a differential pore distribution determined by a BJH method based on a nitrogen adsorption isotherm of the porous layer 3 according to at least one embodiment of the present invention. In the differential pore distribution in nitrogen adsorption, a diameter of a pore at a time when a differential pore volume becomes maximum is defined as dN₂. dN₂ takes a value close to a diameter of a pore obtained by image observation with a scanning electron microscope (SEM).

It is desired that dN₂ be 5 nm or more and 20 nm or less in order to ensure the moisture absorption amount. When dN₂ is 5 nm or more, the porous layer 3 does not absorb moisture at low humidity (humidity of less than 60% RH), and the moisture absorption amount at high humidity (60% RH or more and less than 90% RH) can be ensured. In addition, when dN₂ is 20 nm or less, water vapor is likely to be condensed, and the moisture absorption amount can be ensured. It is preferred that the volume of the pores (pore volume) be 0.37 cm³/g or more.

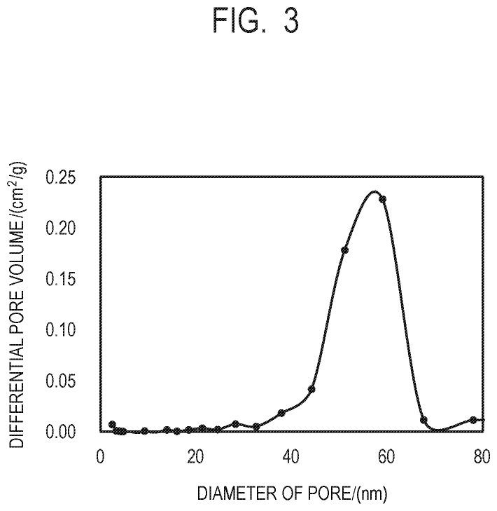

FIG. 3 is a graph for showing a differential pore distribution determined by a BJH method based on a water vapor adsorption isotherm of the porous layer 3 according to at least one embodiment of the present invention. In the differential pore distribution in water vapor adsorption, a diameter of a pore at a time when a differential pore volume becomes maximum is defined as dH₂O.

It is desired that dH₂O of the porous layer 3 be 25 nm or more and 75 nm or less. When dH₂O is 25 nm or more, the pore surface does not become excessively hydrophilic, and capillary condensation does not occur at high humidity (60% RH or more and less than 90% RH). Therefore, a refractive index is not changed at high humidity (60% RH or more and less than 90% RH). When dH₂O is 75 nm or less, the pore surface does not become excessively hydrophobic, and thus dH₂O falls within a range in which water vapor is likely to be condensed. Therefore, the moisture absorption amount can be ensured. When dH₂O is 25 nm or more and 75 nm or less, moisture absorption at a humidity of less than 90% RH can be suppressed to reduce a change in refractive index, and moisture can be absorbed at ultra-high humidity (90% RH or more) to ensure the moisture absorption amount.

dH₂O indirectly represents hydrophilicity and hydrophobicity of the pore surface by a distance, and as the value of dH₂O is larger than the value of dN₂, the surface becomes more hydrophobic. Therefore, in the porous layer 3 according to at least one embodiment of the present invention, a value obtained by dividing dH₂O by dN₂ is preferably 1.25 or more and 15 or less, more preferably 2.5 or more and 6.2 or less.

As the reason why a change in refractive index can be reduced and the moisture absorption amount can be maintained, the following can be considered. When dH₂O falls within the above-mentioned range, the pore surface of the porous layer 3 is hydrophobic at a humidity of less than 90% RH, and hence water vapor is less likely to be condensed. Therefore, at a humidity of less than 90% RH, the porous layer 3 according to at least one embodiment of the present invention is less likely to absorb moisture, and a refractive index is not changed, either. However, when the humidity approaches 90% RH, water molecules gradually adsorb to the pore surface of the porous layer 3, and a portion of the pore surface to which the water molecules have adsorbed is hydrophilized. When the humidity reaches 90% RH or more, the entire pore surface is hydrophilized, and water vapor is likely to be condensed in the porous layer 3, with the result that the moisture absorption amount can be ensured.

The porous layer 3 may be a layer deposited in vacuum or a layer obtained by forming a precursor of the inorganic substance 4 into a film through wet film formation by a sol-gel method or the like.

As the inorganic substance 4 contained in the porous layer 3, any inorganic substance can be used as long as the inorganic substance satisfies the above-mentioned contact angle with respect to water, dN₂, and dH₂O. Specific examples of the inorganic substance 4 include silica and zirconia. Of those, silica is preferably contained as a main component in the inorganic substance 4 in order to reduce a refractive index of the porous layer 3 and improve chemical stability thereof.

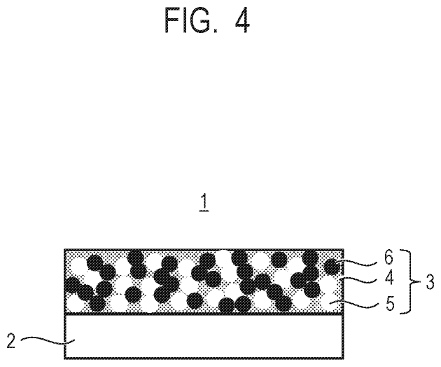

FIG. 4 is a schematic view for illustrating a member according to at least one embodiment of the present invention.

In the member 1 illustrated in FIG. 4, the inorganic substance 4 contains inorganic particles 6 in the porous layer 3, and preferably, the inorganic substance 4 is formed of the inorganic particles 6. It is preferred that the inorganic substance 4 be formed of the inorganic particles 6 from the viewpoint that the pores 5 can be easily connected to each other and that an average diameter of a pore and porosity can be made constant. The porous layer 3 in which the inorganic substance 4 is formed of the inorganic particles 6 can be formed from a dispersion liquid of the inorganic particles 6 through wet film formation.

It is preferred that the amount of the inorganic particles 6 contained in the porous layer 3 be 80 wt % or more.

The shape of each of the inorganic particles 6 can be appropriately selected to be used from various shapes, such as a spherical shape, a chain shape, a disc shape, an elliptic shape, a bar shape, a needle shape, and a square shape. The spherical shape or the chain shape is preferred, and the chain shape is more preferred from the viewpoint that film formability is excellent and that porosity can be increased while sufficient film hardness is obtained.

The chain particles that can be used as the inorganic particles 6 in the present invention refer to an aggregate of particles in which a plurality of particles are linked to each other linearly in the shape of a chain or beads or while being curved. The shape of an individual particle forming the chain inorganic particles may be a shape that can be clearly observed or a shape that cannot be clearly observed because the shape collapses due to fusion. It is only required that the structure of the chain particles be maintained when a layer is formed. In this case, an air gap between the particles can be enlarged as compared to the case using spherical particles and the like, and hence the porous layer 3 having high porosity can be formed.

It is preferred that the average particle diameter of the inorganic particles 6 be 8 nm or more and 25 nm or less. The average particle diameter takes a value close to dN₂. Therefore, when the average particle diameter is 8 nm or more and 25 nm or less, the value of dN₂ becomes 5 nm or more and 20 nm or less, with the result that the moisture absorption amount can be ensured.

When the inorganic particles 6 each have a chain shape, a bar shape, or a needle shape, the inorganic particles 6 are particles each having a shape with a short diameter and a long diameter, and a ratio of the long diameter to the short diameter is preferably 3 or more and 12 or less. When the ratio of the long diameter to the short diameter is 3 or more, the effect of increasing porosity is easily obtained. When the ratio of the long diameter to the short diameter is 12 or less, the average diameter of the pore falls within a certain range, and transparency can be kept by suppressing scattering of light. It is more preferred that the ratio of the long diameter to the short diameter be 4 or more and 10 or less. The ratio of the long diameter to the short diameter can be calculated by observing a transmission electron microscope image.

In this case, the average particle diameter of the inorganic particles 6 refers to a particle diameter (BET particle diameter) calculated through use of a BET method. The BET particle diameter can be calculated based on a specific surface area calculated by subjecting a nitrogen adsorption isotherm measured by a nitrogen gas adsorption method to BET analysis. When a BET particle diameter, a specific surface area, and density of elements forming the inorganic particles 6 are represented by d (nm), A (m²/g), and ρ (g/cm³), respectively, the calculation method can be represented by the following expression (1).

d=6000/(A×ρ) (1)

Particles each having a shape other than the chain shape, such as a perfect circle shape, an elliptic shape, a disc shape, a bar shape, a needle shape, or a square shape, may be appropriately mixed in the inorganic particles 6 in addition to the chain particles. The ratio at which the particles each having a shape other than the chain shape can be mixed with respect to the entire porous layer 3 is preferably 40 wt % or less, more preferably 20 wt % or less.

Examples of the main component of the inorganic particles 6 include silica and zirconia. It is preferred that silica be used as the main component of the inorganic particles 6 in order to reduce a refractive index of the porous layer 3 and improve chemical stability thereof.

Silica particles can be coupled to each other in order to enhance scratch resistance of the porous layer 3. As a method of coupling the silica particles to each other, there are given a method involving physically coupling the silica particles to each other through use of a binder and a method involving chemically binding the silica particles to each other through a silanol group increased in activity. As a method involving chemically binding the silica particles to each other, there are given a method involving treating the surface of each silica particle with a strong acid or the like and a method involving causing a silanol group to adhere to the surface of each silica particle.

It is preferred that a binder to be added in order to couple the silica particles to each other be a silane compound. A suitable example of the silane compound is a silicon oxide oligomer obtained by hydrolytic condensation of a silicic acid ester.

It is preferred that the amount of the silane compound in the porous layer 3 be 1 wt % or more and 30 wt % or less in terms of SiO₂ with respect to the silica particles serving as the inorganic particles 6. When the amount of the silane compound is 1 wt % or more, the scratch resistance of the porous layer 3 becomes sufficient. When the amount of the silane compound is 30 wt % or less, part of the pores 5 are not filled with the silane compound, with the result that the antifogging performance of the porous layer 3 can be kept. The amount of the silane compound is more preferably 4 wt % or more and 20 wt % or less in terms of SiO₂.

The thickness of the porous layer 3 is preferably from 100 nm to 5 μm, more preferably from 500 nm to 3 μm. When the thickness of the porous layer 3 is 100 nm or more, the moisture absorption amount can be easily ensured. In addition, it is preferred that the thickness of the porous layer 3 be 5 μm or less because occurrence of scattering of light can be suppressed.

(Base Material)

As the base material 2, glass, a resin, or the like can be used. When the member 1 is used as an optical member, a base material 2 having a light transmittance in a visible light range of 70% or more (transparent base material) is used. In addition, there is no limitation on the shape thereof, and the base material 2 may have a flat surface, a curved surface, a concave surface, a convex surface, or a film shape.

As the glass, inorganic glass containing, for example, zirconium oxide, titanium oxide, tantalum oxide, niobium oxide, hafnium oxide, lanthanum oxide, gadolinium oxide, silicon oxide, calcium oxide, barium oxide, sodium oxide, potassium oxide, boron oxide, or aluminum oxide may be used. As the glass base material, a glass base material formed by grind polishing, mold forming, float forming, or the like may be used.

Examples of the resin include polyethylene terephthalate, polyethylene naphthalate, triacetyl cellulose, an acrylic resin, polycarbonate, a cycloolefin polymer, and polyvinyl alcohol.

In order to improve adhesiveness, strength, flatness, and the like of the base material 2 and impart functions such as an antireflection function and an antiglare property to the base material 2, the surface of the base material 2 can be washed and polished, and an adhesive layer, a hard coat layer, a refractive index regulating layer, or the like can be formed between the porous layer 3 and the base material 2.

(Manufacturing Method)

Regarding a method of manufacturing a member according to at least one embodiment of the present invention, the member 1 including, as the porous layer 3, a silica porous film containing silica as the inorganic substance 4 is described as one example.

A method of manufacturing the member 1 in which the porous layer 3 is formed on at least any one of surfaces of the base material 2 includes: preparing a silica particle dispersion liquid containing an organic silane compound having a hydrophobic functional group and silica particles in a solvent; applying the silica particle dispersion liquid onto one of the base material 2 and another layer formed on the base material 2, to thereby form a coating film of the silica particle dispersion liquid; and drying the coating film of the silica particle dispersion liquid to form the porous layer 3.

It is preferred that the step of forming the porous layer 3 be a step using a dispersion liquid in which the inorganic particles 6 containing silica as a main component are dispersed.

The dispersion liquid of silica particles to be used for forming the porous layer 3 is prepared, for example, by: a method involving diluting a dispersion liquid of silica particles produced by a wet method, such as a sol-gel method or a hydrothermal synthesis method, with water or a solvent; a method involving substituting the solvent of a similar dispersion liquid with a desired solvent through distilling or ultrafiltration; or a method involving dispersing silica particles synthesized by a dry method, such as fumed silica, in water or a solvent through use of an ultrasonic wave, a bead mill, or the like.

It is preferred that the binder to be added in order to couple the silica particles to each other be an organic silane compound. A suitable example of the organic silane compound is a silicon oxide oligomer obtained by hydrolytic condensation of a silicic acid ester.

As a method of preparing the silicon oxide oligomer, there are given, for example, a method involving mixing a silicon oxide oligomer solution prepared in water or a solvent in advance with a dispersion liquid of silica particles and a method involving mixing a raw material for the silicon oxide oligomer with a dispersion liquid of silica particles and converting the resultant into a silicon oxide oligomer. The silicon oxide oligomer is prepared by adding water, an acid, or a base to a silicic acid ester, such as methyl silicate or ethyl silicate, in a solvent or a dispersion liquid, and subjecting the resultant to hydrolytic condensation. Examples of the acid that can be used for hydrolytic condensation of the silicic acid ester include hydrochloric acid, nitric acid, methanesulfonic acid, trifluoroacetic acid, trifluoromethanesulfonic acid, phosphoric acid, and p-toluenesulfonic acid. Examples of the base that can be used for hydrolytic condensation of the silicic acid ester include ammonia and various amines. The acid and base are selected in consideration of the solubility in a solvent and the reactivity of the silicic acid ester. When a binder solution is prepared, the binder solution can also be heated at a temperature of 80° C. or less.

It is preferred that the weight-average molecular weight of a silicon oxide condensate contained in the binder solution be 500 or more and 3,000 or less in terms of polystyrene. When the weight-average molecular weight is 500 or more, the generation of cracks after curing can be suppressed, and in addition, the stability of the binder solution as a coating material can be kept. In addition, when the weight-average molecular weight is 3,000 or less, an increase in viscosity of the binder solution can be suppressed, and hence voids in the binder are likely to become uniform.

It is required to introduce a hydrophobic functional group into the pore surface in order to set dH₂O to be 25 nm or more and 75 nm or less. As such method, there are given a method involving introducing a hydrophobic functional group during synthesis of silica particles, a method involving introducing a hydrophobic functional group into silica particles after the synthesis, and a method involving introducing a hydrophobic functional group into the pore surface after film formation.

As a treatment agent to be used in introducing a hydrophobic functional group, there is given an organic silane compound. Examples thereof include: alkoxysilanes each having one kind or two or more kinds of substituted alkyl groups, phenyl groups, vinyl groups, or the like in a molecule, such as methyltrimethoxysilane, dimethyldimethoxysilane, trimethylmethoxysilane, methyltriethoxysilane, dimethyldiethoxysilane, trimethylethoxysilane, ethyltrimethoxysilane, ethyltriethoxysilane, propyltrimethoxysilane, propyltriethoxysilane, phenyltrimethoxysilane, benzyltriethoxysilane, propyltrimethoxysilane, propyltriethoxysilane, diethoxymethylphenylsilane, allyltriethoxysilane, vinyltriethoxysilane, aminopropyltriethoxysilane, aminopropyltrimethoxysilane, and hexamethyldisilazane; and chlorosilanes, such as trimethylchlorosilane and diethyldichlorosilane. Of those, organic silane compounds each having a hydrophobic functional group having 1 to 3 carbon atoms, such as methyltrimethoxysilane, methyltriethoxysilane, dimethyldimethoxysilane, dimethyldiethoxysilane, hexamethyldisilazane, ethyltrimethoxysilane, ethyltriethoxysilane, propyltrimethoxysilane, and propyltriethoxysilane, are preferably used. When the hydrophobic functional group has 1 to 3 carbon atoms, the pore surface is more likely to change from hydrophobic to hydrophilic through temperature change.

As the solvent that may be used for the dispersion liquid of silica particles, any solvent may be used as long as the raw material is homogeneously dissolved and a reaction product does not precipitate. Examples thereof include: monohydric alcohols, such as methanol, ethanol, 1-propanol, 2-propanol, 1-butanol, 2-butanol, 2-methylpropanol, 1-pentanol, 2-pentanol, cyclopentanol, 2-methylbutanol, 3-methylbutanol, 1-hexanol, 2-hexanol, 3-hexanol, 4-methyl-2-pentanol, 2-methyl-1-pentanol, 2-ethylbutanol, 2,4-dimethyl-3-pentanol, 3-ethylbutanol, 1-heptanol, 2-heptanol, 1-octanol, and 2-octanol; dihydric or higher alcohols, such as ethylene glycol and triethylene glycol; ether alcohols, such as methoxyethanol, ethoxyethanol, propoxyethanol, isopropoxyethanol, butoxyethanol, 1-methoxy-2-propanol, 1-ethoxy-2-propanol, and 1-propoxy-2-propanol; ethers, such as dimethoxyethane, diglyme, tetrahydrofuran, dioxane, diisopropyl ether, dibutyl ether, and cyclopentyl methyl ether; esters, such as ethyl formate, ethyl acetate, n-butyl acetate, ethylene glycol monomethyl ether acetate, ethylene glycol monoethyl ether acetate, ethylene glycol monobutyl ether acetate, and propylene glycol monomethyl ether acetate; various aliphatic or alicyclic hydrocarbons, such as n-hexane, n-octane, cyclohexane, cyclopentane, and cyclooctane; various aromatic hydrocarbons, such as toluene, xylene, and ethylbenzene; various ketones, such as acetone, methyl ethyl ketone, methyl isobutyl ketone, cyclopentanone, and cyclohexanone; various chlorinated hydrocarbons, such as chloroform, methylene chloride, carbon tetrachloride, and tetrachloroethane; and aprotic polar solvents, such as N-methylpyrrolidone, N,N-dimethylformamide, N,N-dimethylacetamide, and ethylene carbonate. Of those, an alcohol having a branched structure containing 5 to 7 carbon atoms, such as 1-methoxy-2-propanol, 1-ethoxy-2-propanol, 1-propoxy-2-propanol, 1-butoxy-2-propanol, 2-i sopropoxyethanol, 3-methoxy-1-butanol, methyl lactate, or ethyl lactate, is preferably used. It is considered that, due to the steric hindrance of the alcohol having a branched structure containing 5 to 7 carbon atoms, part of the hydroxyl groups on each surface of the silica particles remain without reacting with the organic silane compound, and hence the surface density of the hydrophobic functional group can be easily controlled. When the chain length (number of carbon atoms) of the alcohol having a branched structure containing 5 to 7 carbon atoms becomes large, the boiling point of the solvent is increased. Therefore, a high drying temperature and/or firing temperature are required in order to vaporize the alcohol, and depending on the base material for manufacturing the porous layer 3, the base material may be damaged by the high temperature to undergo deformation, discoloration, and the like. Therefore, as the alcohol having a branched structure containing 5 to 7 carbon atoms, a solvent having a lower boiling point is preferred. However, when the boiling point is excessively low, there arises a problem in that an air gap is enlarged due to abrupt vaporization of the solvent, and dN₂ exceeds 20 nm, with the result that the porous layer is less likely to ensure the moisture absorption amount. The dispersibility of the silica particles may be decreased depending on the surface density of the hydrophobic functional group, but it is considered that the dispersibility can be maintained through use of the alcohol having a branched structure containing 5 to 7 carbon atoms. As the solvent, two kinds of solvents can also be mixed to be used.

As a method of applying the dispersion liquid for forming the porous layer 3 onto the base material, there are given a spin coating method, a spray method, a blade coating method, a roll coating method, a slit coating method, a printing method, a dip coating method, and the like. When a member having a three-dimensionally complicated shape, such as a concave surface, is manufactured, the spin coating method and the spray method are preferred from the viewpoint of the uniformity of the thickness of the layer.

After the dispersion liquid is applied in order to form the porous layer 3, drying and curing are performed. Drying and curing are a process for removing the solvent and accelerating the reaction between the silicon oxide binders or between the silicon oxide binders and the silica particles. The temperature for drying and curing is preferably 20° C. or more and 200° C. or less, more preferably 60° C. or more and 150° C. or less. When the temperature for drying and curing is less than 20° C., the solvent remains, and the abrasion resistance is decreased. In addition, when the temperature for drying and curing exceeds 200° C., the curing of the binders proceeds excessively, and the binders are liable to be cracked. The period of time for drying and curing is preferably 5 minutes or more and 24 hours or less, more preferably 15 minutes or more and 5 hours or less. When the period of time for drying and curing is less than 5 minutes, the solvent remains partially, and fogging is liable to occur partially. When the period of time for drying and curing exceeds 24 hours, cracks are liable to be formed in the layer.

(Application Example)

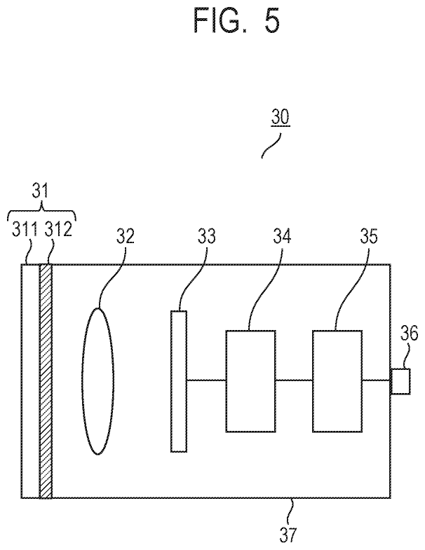

As an example in which the member according to at least one embodiment of the present invention is suitably used, the case using the member as a protection cover for an image pickup apparatus is described. FIG. 5 is view for schematically illustrating a configuration example of an image pickup apparatus.

An image pickup apparatus 30 has a space surrounded by a protection cover 31 serving as the member according to at least one embodiment of the present invention and a housing 37. A lens 32, an image pickup sensor 33, a video engine 34, and a compressed output circuit 35 are arranged in the space, and further an output portion 36 is provided inside or outside the space.

An image entering from outside is guided to the image pickup sensor 33 by the protection cover 31 and the lens 32, and is converted into a video analog signal (electric signal) by the image pickup sensor 33 to be output. The video analog signal output from the image pickup sensor 33 is converted into a video digital signal by the video engine 34, and the video digital signal output from the video engine 34 is compressed into a digital file by the compressed output circuit 35. The video engine 34 may perform processing of adjusting image quality, such as brightness, contrast, color correction, and noise removal, in a process of converting the video analog signal into the video digital signal. The signal output from the compressed output circuit 35 is output from the output portion 36 to external equipment through wiring and/or a network.

The protection cover 31 has a configuration in which a porous layer 312 is formed on at least any one of surfaces of a base material 311, and in the configuration example of the image pickup apparatus illustrated in FIG. 5, the protection cover 31 is arranged so that the surface on which the porous layer 312 is formed is positioned on an inner side of the housing 37. The base material 311 is a transparent member configured to transmit the image entering the image pickup sensor 33. In this case, the term “transparent member” refers to a member having a light transmittance in a visible light range of 70% or more.

With such configuration, in the space surrounded by the protection cover 31 and the housing 37 (in the housing), the inflow and outflow of air with respect to outside is limited, and in addition, following of a change in temperature in an outside environment is delayed. For example, when the temperature of the outside is suddenly lowered, the temperature of the protection cover 31 positioned in a boundary between the outside and the inside of the housing 37 may become lower than a dew-point temperature in the housing. In such case, when the protection cover 31 does not have an antifogging function, water droplets adhere to a surface of the protection cover 31 on the inner side of the housing 37. However, in the case of the protection cover 31 in at least one embodiment of the present invention, even when the temperature of the protection cover 31 becomes lower than the dew-point temperature in the housing 37, moisture in the housing 37 adsorbs to pore inner portions of the porous layer 312. Therefore, water droplets causing fogging are not formed on the surface of the protection cover 31, and hence fogging can be suppressed.

As a modification of the embodiment shown in FIG. 5, the porous layer 312 may be provided on at least one of inner walls of the housing 37 instead providing the porous layer 312 on the surface of the protection cover 31. In this case, the inner wall is used as the base material. In the modification, fogging can be suppressed as well as the porous layer 312 on the surface of the protection cover 31. In addition, the porous layer 312 may be provided on the inner wall of the housing 37 in addition to provide the porous layer 312 on the surface of the protection cover 31. According to such the construction, moisture in the housing 37 adsorbs to pore inner portions of the porous layer 312 provided on the surface of the protection cover 31 and on the inner wall of the housing 37, and hence fogging can be suppressed further.

An antireflection layer and/or an antireflection structure are often provided on the inner wall of the housing 37 in order to suppress deterioration of the image by the light that enters in the housing 37 via the protection cover 31 and that is reflected on the inner wall of the housing 37. Accordingly, when the member according to the present invention is applied to the inner wall of the housing 37, moisture absorption at a humidity of less than 90% RH can be suppressed to reduce a change in refractive index of the porous layer 312, and moisture can be absorbed at ultra-high humidity (90% RH or more) to ensure the moisture absorption amount.

An image pickup system can be configured by adding a pan tilt configured to adjust an angle of view, a controller configured to control an image pickup condition and the like, a storage device configured to store acquired video data, a transfer unit configured to transfer data output from the output portion 36 to outside, and the like to the image pickup apparatus 30.

### EXAMPLES

Now, the present invention is more specifically described by way of Examples. However, the present invention is not limited to Examples below without departing from the gist of the present invention.

(1) Preparation of Particle Dispersion Liquid

(Preparation of Silica Particle Dispersion Liquid 1)

A mixed solution B containing 375 g of tetramethoxysilane, 125 g of 1-propoxy-2-propanol, and 37 g of methyltriethoxysilane serving as a hydrophobic functional group treatment agent was dropped onto a mixed solution A with an ammonia concentration of 0.69 wt % containing 750 g of pure water, 138 g of 25% ammonia water, and 4,112 g of 1-propoxy-2-propanol with stirring at 10° C. over 30 minutes. After dropping, the resultant was stirred at 50° C. for 5 hours to prepare a sol solution. This particle solution was concentrated by heating under reduced pressure. The concentrate was caused to pass through an ion exchange resin (Amberlite IR 120B H AG manufactured by Organo Corporation) to remove ammonia, to thereby set the pH of the sol solution to 8 or less. After that, the resultant was continued to be distilled with dropping of 1-propoxy-2-propanol until moisture reached 1% or less, and was filtrated through use of a 3 μm membrane filter to prepare a silica particle dispersion liquid 1 with a solid content concentration of 15 wt %.

(Preparation of Silica Particle Dispersion Liquid 2)

A silica particle dispersion liquid 2 was prepared in the same manner as in the silica particle dispersion liquid 1 except that 22 g of propyltriethoxysilane was added as the hydrophobic functional group treatment agent of the mixed solution B.

(Preparation of Silica Particle Dispersion Liquid 3)

A silica particle dispersion liquid 3 was prepared in the same manner as in the silica particle dispersion liquid 1 except that 25 g of dimethyldimethoxysilane was added as the hydrophobic functional group treatment agent of the mixed solution B.

(Preparation of Silica Particle Dispersion Liquid 4)

A silica particle dispersion liquid 4 was prepared in the same manner as in the silica particle dispersion liquid 1 except that the amount of 25% ammonia water was set to 185 g and the amount of 1-propoxy-2-propanol was set to 4,065 g so that the ammonia concentration of the mixed solution A was 0.92 wt %.

(Preparation of Silica Particle Dispersion Liquid 5)

A silica particle dispersion liquid 5 was prepared in the same manner as in the silica particle dispersion liquid 1 except that the amount of 25% ammonia water was set to 111 g and the amount of 1-propoxy-2-propanol was set to 4,139 g so that the ammonia concentration of the mixed solution A was 0.56 wt %.

(Preparation of Silica Particle Dispersion Liquid 6)

2-Propanol was distilled away from a 2-propanol (IPA) dispersion liquid of chain silica particles (IPA-ST-UP (trademark) manufactured by Nissan Chemical Corporation, having a particle diameter measured by the BET method of 12 nm and a solid content concentration of 15 wt %) through use of an evaporator to substitute 2-propanol with 1-propoxy-2-propanol, to thereby prepare 1,212 g of a 1-propoxy-2-propanol dispersion liquid of chain silica particles (solid content concentration: 33 wt %).

548 g of 1-propoxy-2-propanol and 907 g of ethyl lactate were added to the 1-propoxy-2-propanol dispersion liquid of chain silica particles, and the mixture was stirred for 10 minutes. Then, 24 g of dimethyldimethoxysilane and 27 g of an acetic acid aqueous solution having a pH of 4 serving as a catalyst were added to the resultant, and the resultant was stirred in an oil bath at 50° C. for 5 hours to prepare a silica particle dispersion liquid 6 having a solid content concentration of 15 wt %.

(Preparation of Silica Particle Dispersion Liquid 7)

A silica particle dispersion liquid 7 was prepared in the same manner as in the silica particle dispersion liquid 1 except that: the amount of 25% ammonia water was set to 192 g and the amount of 1-propoxy-2-propanol was set to 4,058 g so that the ammonia concentration of the mixed solution A was 0.96 wt %; and the temperature was kept at 50° C. when the mixed solution B was dropped onto the mixed solution A.

(Preparation of Silica Particle Dispersion Liquid 8)

A silica particle dispersion liquid 8 was prepared in the same manner as in the silica particle dispersion liquid 1 except that the hydrophobic functional group treatment agent was not added.

(Preparation of Silica Particle Dispersion Liquid 9)

A silica particle dispersion liquid 9 was prepared in the same manner as in the silica particle dispersion liquid 1 except that 43 g of propyltriethoxysilane was added as the hydrophobic functional group treatment agent of the mixed solution B.

(Preparation of Silica Particle Dispersion Liquid 10)

A silica particle dispersion liquid 10 was prepared in the same manner as in the silica particle dispersion liquid 3 except that the amount of 25% ammonia water was set to 192 g and the amount of 1-propoxy-2-propanol was set to 4,058 g so that the ammonia concentration of the mixed solution A was 0.96 wt %.

(Preparation of Silica Particle Dispersion Liquid 11)

A silica particle dispersion liquid 11 was prepared in the same manner as in the silica particle dispersion liquid 1 except that the amount of 25% ammonia water was set to 105 g and the amount of 1-propoxy-2-propanol was set to 4,145 g so that the ammonia concentration of the mixed solution A was 0.52 wt %.

(2) Manufacturing of Member

### Example 1

In Example 1, an appropriate amount of the silica particle dispersion liquid 1 was dropped onto a flat glass substrate of ϕ30 mm (S-BSL7, nd=1.52, manufactured by Ohara Inc.) and spin coating was performed at 1,000 rpm for 30 seconds. Then, the resultant was fired for 30 minutes in a circulating hot air oven at 140° C. to manufacture a member of Example 1. The thickness of a porous layer of the member of Example 1 was 2.6 μm.

### Examples 2 to 6 and Comparative Examples 1 and 5

Members of Examples 2 to 6 and members of Comparative Examples 1 to 5 were each manufactured in the same manner as in Example 1 except that a silica particle dispersion liquid shown in Table 1 was used in place of the silica particle dispersion liquid 1. The thickness of a porous layer of each of the members of Examples 2 to 6 and the members of Comparative Examples 1 to 5 is shown in Table 1.

(3) Evaluation

The member obtained in each of Examples and Comparative Examples was evaluated by the following method. The results are shown in Table 1.

(3-1) Measurement of dN₂

A nitrogen adsorption isotherm at −196° C. was measured through use of an automatic vapor adsorption amount measurement apparatus (BELSORP-MAX manufactured by BEL Japan, Inc.), and a differential pore distribution was obtained by a BJH method. In the obtained differential pore distribution, a diameter of a pore at a time when a differential pore volume became maximum was defined as dN₂.

(3-2) Measurement of dH₂O

An adsorption isotherm at 25° C. was measured through use of an automatic vapor adsorption amount measurement apparatus (BELSORP18 manufactured by BEL Japan, Inc.), and a differential pore distribution was obtained by the BJH method. In the obtained differential pore distribution, a diameter of a pore at a time when a differential pore volume became maximum was defined as dH₂O.

(3-3) Measurement of Pore Volume

A nitrogen adsorption isotherm at −196° C. was measured through use of an automatic vapor adsorption amount measurement apparatus (BELSORP-MAX manufactured by BEL Japan, Inc.), and a pore volume was determined by the BJH method.

(3-4) Measurement of Average Particle Diameter

A nitrogen adsorption isotherm at −196° C. was measured through use of an automatic vapor adsorption amount measurement apparatus (BELSORP-MAX manufactured by BEL Japan, Inc.), and a specific surface area A (m²/g) was determined by the BET method. Then, an average particle diameter, and density of silicon oxide forming inorganic particles were set to d (nm) and 202 (g/cm³), respectively, and an average particle diameter obtained by the BET method (BET particle diameter) was determined by the following expression (2).

d=6000/(A×2.2) (2)

(3-5) Evaluation of Contact Angle

A contact angle at a time of contact of a liquid droplet of 2 μl of pure water was measured in an environment at a temperature of 23° C. and a humidity of 40% RH through use of a full automatic contact angle meter (DM-701 manufactured by Kyowa Interface Science Co., Ltd.).

(3-6) Measurement of Refractive Index

The member was allowed to stand still for 1 hour in an environment at a temperature of 25° C. and a humidity of 60% RH, 80% RH, 90% RH, or 95% RH. After that, a reflectance was measured at each humidity through use of a reflectometer (URE-50 manufactured by Ushio Inc.). A refractive index at a wavelength of 550 nm was determined based on reflectance data through use of analysis software (WVASE manufactured by J. A Woollam). A change in refractive index was evaluated from the obtained refractive indices based on the following criteria.

A: The difference between the refractive indices of the member at the humidity of 60% RH and the humidity of 95% RH is less than 0.015.

B: The difference between the refractive indices of the member at the humidity of 60% RH and the humidity of 90% RH is less than 0.015, and the difference between the refractive indices of the member at the humidity of 60% RH and the humidity of 95% RH is 0.015 or more.

C: The difference between the refractive indices of the member at the humidity of 60% RH and the humidity of 90% RH is 0.015 or more.

(3-7) Evaluation of Antifogging Property

A moisture absorption amount at a time when the relative humidity was changed from 60% RH to 98% RH was measured through use of an automatic vapor adsorption amount measurement apparatus (BELSORP18 manufactured by BEL Japan, Inc.). The obtained moisture absorption amount was evaluated based on the following criteria.

A: 350 (cm³/g) or more

B: 250 (cm³/g) or more and less than 350 (cm³/g)

C: Less than 250 (cm³/g)

TABLE 1

| | | | | | | Thickness | | | | Antifogging property | |
|---|---|---|---|---|---|---|---|---|---|---|---|
| | | | | | | of the | Change in refractive index | | | Moisture | |
| | | | | Pore | Contact | porous | 60% RH | 60% RH | | absorption | |
| | | dN₂ | dH₂O | volume | angle | layer | to | to | | amount | |
| | Dispersion Liquid | (nm) | (nm) | (cm³/g) | (°) | (μm) | 90% RH | 95% RH | Evaluation | (cm³/g) | Evaluation |
| Example 1 | Silica Particle Dispersion | 11.8 | 73.0 | 0.38 | 39 | 2.6 | 0.001 | 0.010 | A | 397 | A |
| | Liquid 1 | | | | | | | | | | |
| Example 2 | Silica Particle Dispersion | 11.0 | 27.3 | 0.44 | 42 | 1.8 | 0.000 | 0.060 | B | 477 | A |
| | Liquid 2 | | | | | | | | | | |
| Example 3 | Silica Particle Dispersion | 12.2 | 57.4 | 0.47 | 57 | 2.2 | 0.000 | 0.000 | A | 290 | B |
| | Liquid 3 | | | | | | | | | | |
| Example 4 | Silica Particle Dispersion | 19.3 | 28.7 | 0.50 | 21 | 2.9 | 0.010 | 0.071 | B | 301 | B |
| | Liquid 4 | | | | | | | | | | |
| Example 5 | Silica Particle Dispersion | 5.8 | 25.1 | 0.37 | 40 | 2.4 | 0.014 | 0.077 | B | 274 | A |
| | Liquid 5 | | | | | | | | | | |
| Example 6 | Silica Particle Dispersion | 11.6 | 51.3 | 0.48 | 45 | 1.4 | 0.000 | 0.020 | B | 415 | A |
| | Liquid 6 | | | | | | | | | | |
| Comparative | Silica Particle Dispersion | 19.1 | 81.3 | 0.43 | 40 | 2.7 | 0.000 | 0.000 | A | 192 | C |
| Example 1 | Liquid 7 | | | | | | | | | | |
| Comparative | Silica Particle Dispersion | 11.1 | 19.0 | 0.44 | 15 | 2.2 | 0.040 | 0.100 | C | 482 | A |
| Example 2 | Liquid 8 | | | | | | | | | | |
| Comparative | Silica Particle Dispersion | 10.6 | 49.3 | 0.38 | 65 | 1.8 | 0.000 | 0.000 | A | 118 | C |
| Example 3 | Liquid 9 | | | | | | | | | | |
| Comparative | Silica Particle Dispersion | 20.7 | 51.8 | 0.51 | 56 | 2.8 | 0.005 | 0.020 | B | 189 | C |
| Example 4 | Liquid 10 | | | | | | | | | | |
| Comparative | Silica Particle Dispersion | 4.9 | 45.1 | 0.31 | 31 | 2.4 | 0.009 | 0.033 | B | 160 | C |
| Example 5 | Liquid 11 | | | | | | | | | | |

### Evaluation of Examples and Comparative Examples

It is understood from the comparison between evaluation results of the members of Examples 1 to 6 that, when dH₂O is 25 nm or more and 75 nm or less, moisture absorption at a humidity of less than 90% RH can be suppressed to reduce a change in refractive index, and moisture can be absorbed at a humidity of 90% RH or more to ensure the moisture absorption amount. In addition, it is also understood that, as dH₂O is larger, a change in refractive index can be further reduced. Meanwhile, it is understood that, in the member of Comparative Example 1, dH₂O is more than 75 nm, and hence the moisture absorption amount cannot be ensured. In addition, in the member of Comparative Example 2, dH₂O is less than 25 nm, and hence a change in refractive index at high humidity (60% RH or more and less than 90% RH) is large.

It is understood from the comparison between the evaluation results of the members of Example 3 and Comparative Example 3 that, when the contact angle reaches 60° or more, the amount of water molecules entering the inside of the layer is significantly reduced, and hence the member of Comparative Example 3 cannot ensure the moisture absorption amount, resulting in an unsatisfactory antifogging property.

It is understood from the comparison between the evaluation results of the members of Example 4 and Comparative Example 4 that, when dN₂ reaches 20 nm or more, water vapor is less likely to be condensed in pores in the porous layer, and the moisture absorption amount is decreased. It is understood from the comparison between the evaluation results of the members of Example 5 and Comparative Example 5 that, when dN₂ reaches 5 nm or less, moisture is absorbed at low humidity (humidity of less than 60% RH), and hence the pores in the porous layer are buried, with the result that the moisture absorption amount cannot be ensured at high humidity (60% RH or more and less than 90% RH).

It is understood from the evaluation results of the member of Example 6 that, also through introduction of hydrophobic functional groups into chain particles, dN₂ can be set to 5 nm or more and 20 nm or less, the contact angle can be set to less than 60°, and dH₂O can be set to 25 nm or more and 75 nm or less. In addition, the dN₂, the dH₂O, and the contact angle of the member of Example 6 fall within the above-mentioned ranges, and hence, it is understood that the reduction of change in refractive index and the maintenance of the moisture absorption amount at high humidity (60% RH or more and less than 90% RH) can be performed.

With the foregoing, it was verified that the members of Examples each including the porous layer that satisfies the requirements of the present invention are excellent both in the reduction of a change in refractive index and the maintenance of the moisture absorption amount as compared to the members of Comparative Examples.

The member according to at least one embodiment of the present invention can be utilized in optical components, such as an optical lens, an optical mirror, an optical filter, and an eyepiece of an image pickup system and a projection system, and a planar cover and a dome cover for an outdoor camera and a monitoring camera, as well as general applications, such as a windowpane, a mirror, a lens, and a transparent film.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-155676, filed Aug. 22, 2018, and Japanese Patent Application No. 2019-143857, filed Aug. 5, 2019, which are hereby incorporated by reference herein in their entirety.

What is claimed is:

1. A member comprising:
a base material; and
a porous layer formed on at least one of surfaces of the base material,
wherein the porous layer has dN₂ of 5 nm or more and 20 nm or less and dH₂O of 25 nm or more and 75 nm or less, and has a contact angle with respect to water of less than 60°,
in which dN₂ is defined as a diameter of a pore at a time when a differential pore volume becomes maximum in the differential pore distribution in nitrogen adsorption and dH₂O is defined as a diameter of a pore at a time when a differential pore volume becomes maximum in the differential pore distribution in water vapor adsorption.

2. The member according to claim 1, wherein the member has a pore volume of 0.37 cm³/g or more.

3. The member according to claim 1, further comprising silica particles.

4. The member according to claim 3, wherein the silica particles comprise chain silica particles.

5. An image pickup apparatus comprising:
a housing;
a protection cover; and
an image pickup sensor arranged in an inner space surrounded by the housing and the protection cover,
wherein the protection cover includes a base material and a porous layer formed on a surface of the base material on a side of the inner space, and
wherein the porous layer has dN₂ of 5 nm or more and 20 nm or less and dH₂O of 25 nm or more and 75 nm or less, and has a contact angle with respect to water of less than 60°,
in which dN₂ is defined as a diameter of a pore at a time when a differential pore volume becomes maximum in the differential pore distribution in nitrogen adsorption and dH₂O is defined as a diameter of a pore at a time when a differential pore volume becomes maximum in the differential pore distribution in water vapor adsorption.

6. The image pickup apparatus according to claim 5, wherein the porous layer has a pore volume of 0.37 cm³/g or more.

7. The image pickup apparatus according to claim 5, wherein the porous layer contains silica particles.

8. The image pickup apparatus according to claim 7, wherein the silica particles comprise chain silica particles.

9. A method of manufacturing the member according to claim 1 comprising:
preparing a silica particle dispersion liquid containing an organic silane compound having a hydrophobic functional group and silica particles in a solvent;
applying the silica particle dispersion liquid onto one of a base material and another layer formed on the base material, to thereby form a coating film of the silica particle dispersion liquid; and
drying the coating film,
the silica particles having an average particle diameter of 8 nm or more and 25 nm or less,
the silica particle dispersion liquid containing the organic silane compound having a hydrophobic functional group in an amount of 1 wt % or more and 30 wt % or less in terms of SiO₂ with respect to the silica particles.

10. The method according to claim 9, wherein the silica particles comprise chain silica particles.

11. The method according to claim 9, wherein the silica particle dispersion liquid further contains a binder.

12. The method according to claim 9, wherein the silica particle dispersion liquid further contains an alcohol having a branched structure containing 5 to 7 carbon atoms.

13. The method according to claim 12, wherein the alcohol having a branched structure containing 5 to 7 carbon atoms comprises 1-propoxy-2-propanol.
